(19) United States
(12) Patent Application Publication
(10) Pub. No.: US 2014/0057617 A1
(43) Pub. Date: Feb. 27, 2014

(54) RADIO DEVICE AND RADIO SIGNAL PROCESSING METHOD

(71) Applicant: FUJITSU LIMITED, Kawasaki-shi (JP)

(72) Inventor: Noboru KOBAYASHI, Tokorozawa (JP)

(21) Appl. No.: 13/912,985

(22) Filed: Jun. 7, 2013

(30) Foreign Application Priority Data
Aug. 27, 2012 (JP) 2012-186958

(51) Int. Cl. H04W 8/22

(52) U.S. Cl. CPC H04W 8/22
USPC 455/418

(57) ABSTRACT

A radio device includes: a processor configured to execute radio communication processing; a first memory configured to store a program module of the radio communication processing, and to operate at a first clock; a second memory configured to store the program module that is transferred from the first memory, and executed by the processor, and to operate at a second clock a speed of which is higher than that of the first clock; and a control circuit configured to: determine the program module that is to be executed by the processor, based on a transition state of radio communication, and control the determined program module to be transferred from the first memory to the second memory.

### CROSS-REFERENCE TO RELATED APPLICATION

This application is based upon and claims the benefit of priority of the prior Japanese Patent Application No. 2012-186958, filed on Aug. 27, 2012, the entire contents of which are incorporated herein by reference.

### FIELD

The embodiments discussed herein are related to a radio device and radio signal processing method.

### BACKGROUND

In a mobile radio communication, new communication systems have been standardized and put to practical use one after another. These communication systems are gradually switched from the old systems. Therefore, in a transitional period between communication systems, in one radio device (mobile terminal), a plurality of communication systems (radio access technology: RAT) such as WCDMA and Long Term Evolution (LTE) are operated. In use of dedicated hardware for each of the plurality of communication systems, the circuit scale of the mobile terminal increases, and an increase in cost, power consumption, and the like are caused. Here, standard for the communication system is updated regularly, and it is desirable to flexibly respond to such update. In addition, in radio signal processing of the mobile terminal, the communication is realized using a semiconductor chip (system on chip: SoC) in which the functions are integrated into a large-scale integration (LSI), or the like.

In addition, it takes a long time of at least several months to change the hardware in the mobile terminal. Therefore, the switching of the communication systems is realized by software defined radio (SDR) by communication processing to the mobile terminal is executed using software (program), or the like of a processor.

In SDR, there are methods of using a processor, reconfigurable hardware, and the like. The SDR is easily achieved by a digital signal processor (DSP) the development approach of which is common, and the usage of DSP is becoming mainstream (for example, Japanese Laid-open Patent Publication No. 2008-165780). In addition, there is a technology in which the SDR is realized by a processor, the progress such as processing delay of the processor is monitor, and contents to be processed after that is determined on the basis of the monitoring result (for example, see Japanese Laid-open Patent Publication No. 2010-278829).

### SUMMARY

According to an aspect of the invention, a radio device includes: a processor configured to execute radio communication processing; a first memory configured to store a program module of the radio communication processing, and to operate at a first clock; a second memory configured to store the program module that is transferred from the first memory, and executed by the processor, and to operate at a second clock a speed of which is higher than that of the first clock; and a control circuit configured to: determine the program module that is to be executed by the processor, based on a transition state of radio communication, and control the determined program module to be transferred from the first memory to the second memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a function of a radio device according to an embodiment;

FIG. 2 is diagram illustrating a configuration example that is related to data transfer according to the embodiment;

FIG. 3 is a diagram illustrating a state transition example of a mobile terminal;

FIG. 4 is diagram illustrating an example of transfer control information generation base on state transition that is performed by a control information generation unit;

FIG. 5 is a timing chart of a program module transfer example based on the state transition;

FIG. 6 is a flowchart illustrating processing contents of each function unit that is related to the program module transfer; and

FIG. 7 is a diagram illustrating another configuration example of the data transfer according to the embodiment.

### DESCRIPTION OF EMBODIMENTS

The embodiments discussed herein are described below in detail with reference to the accompanying drawings.

While inventing the present embodiments, observations were made regarding a related art. Such observations include the following, for example.

In the related art, when SDR is realized by a DSP, there is desired an instruction memory to retain an instruction of the DSP in addition to a memory that is desired in principal to realize a DSP processing algorithm. In addition, with the complication of recent radio systems, high performance of the DSP is desired as well. In addition, in a complicated instruction set that is used for communication processing, an instruction having a high degree of parallelism, or the like, the program size increases as the instruction words increase. It is desirable that such an instruction memory is operated at a high speed similar to a clock cycle of the DSP, and it is desirable that the instruction memory is provided in a SoC when the instruction memory is constituted by an SRAM, so that the chip size of the SoC increases. In addition, when a plurality of radio systems (RAT) are realized in one piece of hardware, it is desirable that a memory capacity that corresponds to the maximum instruction memory of each of the RAT is prepared.

On the other hand, there is conceived a configuration in which a low-speed SDRAM, or the like is connected to the outside of the SoC, and a high-speed memory (cache memory) that includes a small capacity and is used for a regular processor is mounted in the SoC. In the SDRAM, a memory cell having one bit may be constituted by one transistor, and a memory having the same capacity may be realized with a small area as compared with an SRAM, however, there is delay until the reading starts because the reading procedure is complicated. The communication processing of a radio layer 1 is executed in synchronization with a radio frame signal, so that real-time processing is desired. Here, in the configuration of the mobile terminal in which the SDRAM is shared with a plurality of functional blocks and a sufficient data transfer band may not be obtained, delay of instruction reading occurs, so that a processing amount that may be obtained within a specified time of the communication is reduced. In this case, processing capacity of the DSP may not be obtained desirably. As described above, in any configurations of the instruction memory of the related arts, there is a problem in the size of the memory and the performance.

Due to the above-described problems, when all programs are stored in the high-speed SRAM, the chip size of the SoC increases. Due to the increase in the chip size of the SoC, an increase in the price of the SoC is caused, and it is difficult to downsize the whole device.

An object of the embodiments is to be compatible with various communication systems in SDR communication and reduce the size of a high-speed memory of a SoC.

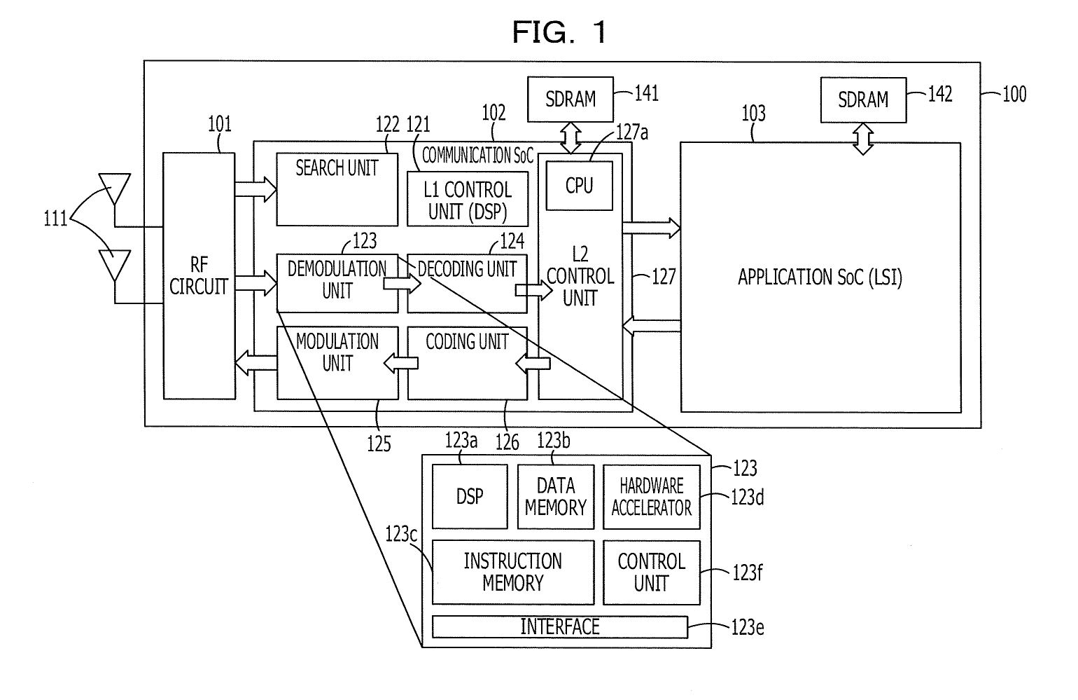

FIG. 1 is a block diagram illustrating a function of a radio device according to an embodiment. In the embodiment, as an example of the radio device, a mobile terminal 100 that performs communication using a radio network, or the like is described.

The mobile terminal 100 includes a radio communication (RF) circuit 101, a communication processing unit (communication SoC) 102 that executes communication processing (base band processing), and an application processing unit (application SoC) 103 that controls input/output processing, and the like on the mobile terminal 100.

An SDRAM 141 as an external memory is connected to the communication processing unit (communication SoC) 102. In the SDRAM 141, data (program module) is stored that is used to execute communication processing of each function unit in the communication processing unit (communication SoC) 102. An SDRAM (first memory) 142 as an external memory is connected to the application processing unit (application SoC) 103. In the SDRAM 142, data is stored that is used to execute application processing in the application processing unit (application SoC) 103.

The RF circuit 101 transmits radio waves to a radio network such as a mobile radio network through an antenna 111 and receives radio waves from the radio network. In the example illustrated in FIG. 1, two antennas are used for reception of radio waves, and one antenna is used for transmission of radio waves. The transmitted and received digital radio signals are input and output between the RF circuit 101 and the communication SoC 102.

In the communication SoC 102, various functional blocks that execute communication processing for the radio signal processing (base band processing) are integrated into a semiconductor chip such as an LSI. The communication SoC 102 converts the received radio signal into an Internet Protocol (IP) signal and converts an IP signal into a radio signal to be transmitted. The communication SoC 102 includes the plurality of functional blocks such as a layer 1 (L1) control unit 121, a search unit 122, a demodulation unit 123, a decoding unit 124, a modulation unit 125, a coding unit 126, and a layer 2 (L2) control unit 127.

The L1 control unit 121 controls communication processing in a layer 1, that is, a lowermost layer (physical layer) of a multi-layer model for communication. The search unit 122 searches for a base station (not illustrated) to which radio waves of the mobile terminal 100 are transmitted. The demodulation unit 123 demodulates the received radio signal. The decoding unit 124 executes decoding processing such as error-correction on the radio signal that is demodulated by the demodulation unit 123 and outputs the radio signal to the L2 control unit 127.

The L2 control unit 127 includes a CPU 127a and controls communication processing of a layer 2, that is, a second layer (data link layer) of the multi-layer model for communication. The L2 control unit 127 performs decoding concealment, and the like on the received radio signal (packet) and converts the received radio signal (packet) into an IP packet. The IP signal is output to the application SoC 103.

The coding unit 126 performs coding of data for transmission, which is output from the L2 control unit 127. The modulation unit 125 modulates the data that is coded by the coding unit 126 and outputs the modulated data to the RF circuit 101. The RF circuit 101 transmits the data that is modulated by the modulation unit 125 to the radio network as a radio signal.

The application SoC 103 is connected to the communication SoC 102. A plurality of application programs that execute processing of image display and audio output for the received data that is output from the communication SoC 102, and processing of input of data to be transmitted, and the like are implemented in the application SoC 103.

In the lower part of FIG. 1, the internal configuration example of the demodulation unit 123 is illustrated. The demodulation unit 123 includes a processor (DSP) 123a, a data memory 123b, an instruction memory 123c, a hardware accelerator 123d, an interface 123e, and a control unit 123f.

The DSP 123a uses the data memory 123b to execute a demodulation processing algorithm, and the instruction memory 123c holds an instruction of the DSP 123a. For the instruction memory 123c, a high-speed memory (second memory) such as SRAM that operates at a clock cycle (second clock) that is the same as the clock cycle of the DSP 123a may be employed. The above-described SDRAM (first memory) 142 operates at the first clock the speed of which is lower than the clock cycle of the DSP 123a.

The hardware accelerator 123d is provided as a circuit that is specific to a part of demodulation processing, and desirably executes the processing at a high speed as compared with the case of using the DSP 123a. The hardware accelerator 123d may be provided as a plurality of circuits having different functions. The interface 123e executes data input/output for the blocks that are connected to the demodulation unit 123 (the RF circuit 101 and the decoding unit 124).

The control unit 123f performs transfer control of a program module that is desired for processing execution of the DSP 123a in the demodulation unit 123. In the transfer control, the program module is transferred from the low-speed memory (SDRAM) 141 to the high-speed memory (SRAM) 123c (the detail is described later).

In the above description, the internal configuration of the demodulation unit 123 is described, and the L1 control unit 121, the search unit 122, the decoding unit 124, the modulation unit 125, and the coding unit 126 that are the other function units of the communication SoC 102 also have the internal configurations (DSP, instruction memory, and the like) that are similar to that of the demodulation unit 123. The low-speed memory (SDRAM) 141 stores all program modules that are desired for execution processing of the function units of the communication SoC 102 (the L1 control unit 121 to the coding unit 126) beforehand. In addition, in response to a request of each of the function units of the communication SoC 102 (the L1 control unit 121 to the coding unit 126), the corresponding program module is transferred to the high-speed memory (SRAM) 123c that is included in each of the function unit (the L1 control unit 121 to the coding unit 126).

(Data Transfer to the Instruction Memory Based on State Transition of the Radio Communication)

In the embodiment, in each of the function units (except for the L2 control unit 127) of the layer 1 in the communication SoC 102 that executes the radio signal processing, a program (program module) that is executed by the processor (DSP) is identified on the basis of state transition of the radio communication.

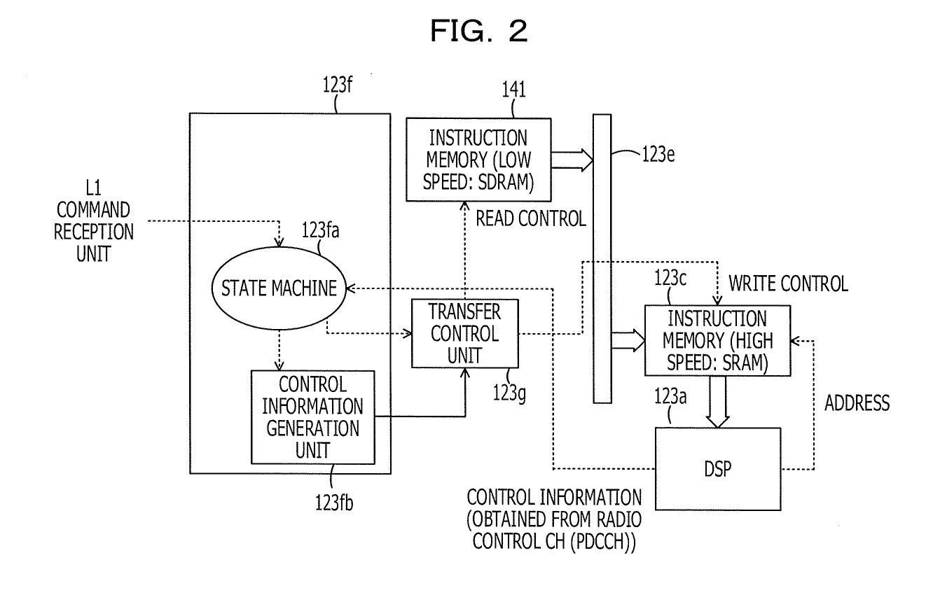

FIG. 2 is a configuration example that is related to data transfer according to the embodiment. In the example of FIG. 2, data transfer of a program module that is desired for execution processing of the DSP 123a of the demodulation unit 123 illustrated in FIG. 1 is described as an example.

The control unit 123f controls the data transfer of the program module that is desired for the execution processing of the DSP 123a. The control unit 123f includes a state machine 123fa, and a control information generation unit 123fb. A transfer control unit 123g corresponds to a part of functions of the DSP 123a.

The state machine 123fa manages state transition (state information) of the mobile terminal 100 (demodulation unit 123) using a radio connection state and radio frame timing (for example, L1 timing) as a trigger. In addition, as the trigger of the state transition, there may be employed a radio timing signal and control information that is obtained by decrypting a control channel of the radio signal (physical downlink control channel: PDCCH, that is, a channel that is used when a downlink control signal of the physical layer is transmitted) by the DSP 123a.

An L1 control command is, for example, a command of an instruction to start and pause to receive downlink reception data from the base station, and has a large size of granularity. In addition, the state machine 123fa specifies a time at which the command is activated using the radio frame, or the like as a unit and performs the state control in accordance with the radio frame timing. In the control information that is input from the DSP 123a, the further detailed information is included. For example, the configuration of an antenna that is used to transmit the downlink reception data (for example, the number of transmission antennas, the number of transmission layers, and the like) may be identified on the basis of the detailed information.

The control information generation unit 123fb generates control information of data transfer on the basis of the state information (radio connection state and radio frame timing) that is managed by the state machine 123fa and outputs the generated control information to the transfer control unit 123g. The control information generation unit 123fb generates information on an address, the size, and transfer timing of the data to be transferred.

The transfer control unit 123g executes and controls data transfer of a program module from the low-speed memory (SDRAM) 141 to the high-speed memory (SRAM) 123c on the basis of the control information of data transfer, which is generated by the control information generation unit 123fb on the basis of the radio connection state.

The data transfer from the low-speed memory (SDRAM) 141 to the high-speed memory (SRAM) 123c is performed similarly to a method of a common cache memory. In the common cache memory, the data transfer is controlled by a simple look-ahead and cache misses. On the contrary, in the embodiment, contents to be processed by the processor (DSP) 123a are identified on the basis of the information on the radio connection state, and data (program module) to be transferred to a high-speed cache (SRAM 123c) is determined.

The processor (DSP) 123a accesses the high-speed memory (SRAM) 123c and reads and executes the program module. As described above, in the transfer of the program module, the radio connection state and the radio frame timing are used. As a result, the DSP 123a may execute the program module that corresponds to the transition state.

(State Transition of the Mobile Terminal)

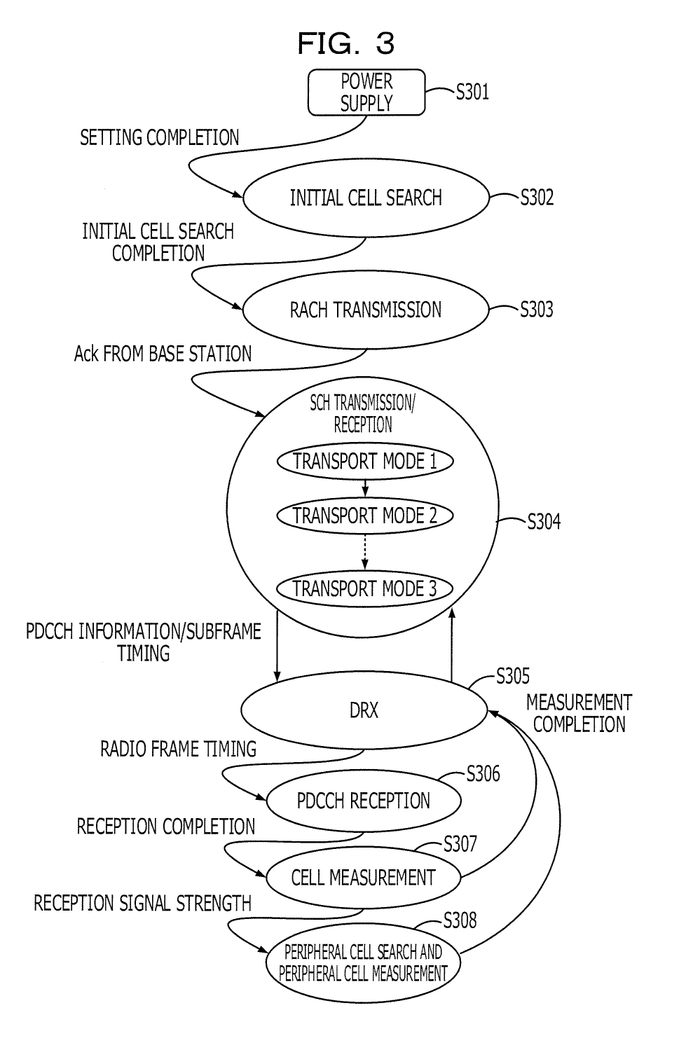

FIG. 3 is a diagram illustrating a state transition example of the mobile terminal. In FIG. 3, power is supplied to the mobile terminal 100, actual communication is performed, and the flow proceeds to a standby state. First, when power is supplied to the mobile terminal 100 (State S301), initial cell search is performed to search for a base station to which the mobile terminal 100 is to be connected (State S302). When the base station is found by the search, random access channel (RACH) transmission is performed to register the mobile terminal 100 to the base station (State S303). The RACH is a channel when the mobile terminal 100 accesses the base station for the first time, and the transmission time is not specified.

When the RACH transmission is completed desirably, the mobile terminal 100 is registered to the base station and the flow proceeds to a state in which regular communication (shared channel: SCH) may be performed (State S304). The SCH is a channel that is used when user data is transmitted, and a plurality of users (mobile terminals 100) use and share the resource. The SCH transmission and reception is a state in which the user usually uses the mobile terminal 100. In such a state (in the SCH transmission and reception), switching to an optimal transport mode (transport modes 1 to 8) is performed in accordance with the radio wave condition, and the transmission and reception are performed.

After that, when transmission and reception of the data is not performed, the flow proceeds to a standby state (discontinuous reception: DRX) (State S305). The DRX is a discontinuous reception state, that is, the standby state, and the reception is represented by Rx, and the transmission is represented by Tx, so that the state is referred to as “DRX”.

In the DRX state, the mobile terminal 100 basically terminates operations of the transmission and reception of data. However, the mobile terminal 100 is periodically activated, receives and monitors a control signal (PDCCH) that is transmitted from the base station, and checks whether or not there is data the destination of which is this mobile terminal 100 (State S306). After that, cell measurement whether or not radio waves of the currently connected base station have sufficient strength is performed (State S307). After that, peripheral cell search and peripheral cell measurement are performed whether or not there exists an adjacent base station having greater radio wave strength (State S308). After completion of the measurement, the flow proceeds to the State S305. In addition, the mobile terminal 100 performs hand-over when the radio wave strength of the adjacent base station increases and changes a base station to which the mobile terminal 100 is to be connected.

FIG. 3 illustrates an example in which a communication system is LTE. In LTE, downlink data from the base station is transmitted to each of the mobile terminals 100 through the SCH. Each of the mobile terminals 100 checks a control signal that is transmitted by the same radio frame as transmitted data and performs demodulation and decoding of data that is transmitted to the own mobile terminal 100. In the transmission of the SCH, the base station selects the number of antennas and a modulation scheme that are optimal for the mobile terminal 100. Contents to be processed of the mobile terminal 100 vary depending on the selection of base station. The transport mode is also regarded as the state transition. In addition, when there is no data to be transmitted and received in a state in which the mobile terminal 100 is registered to the base station, the flow proceeds to the DRX state.

(Example of Transfer Control Information Generation Based on the State Transition)

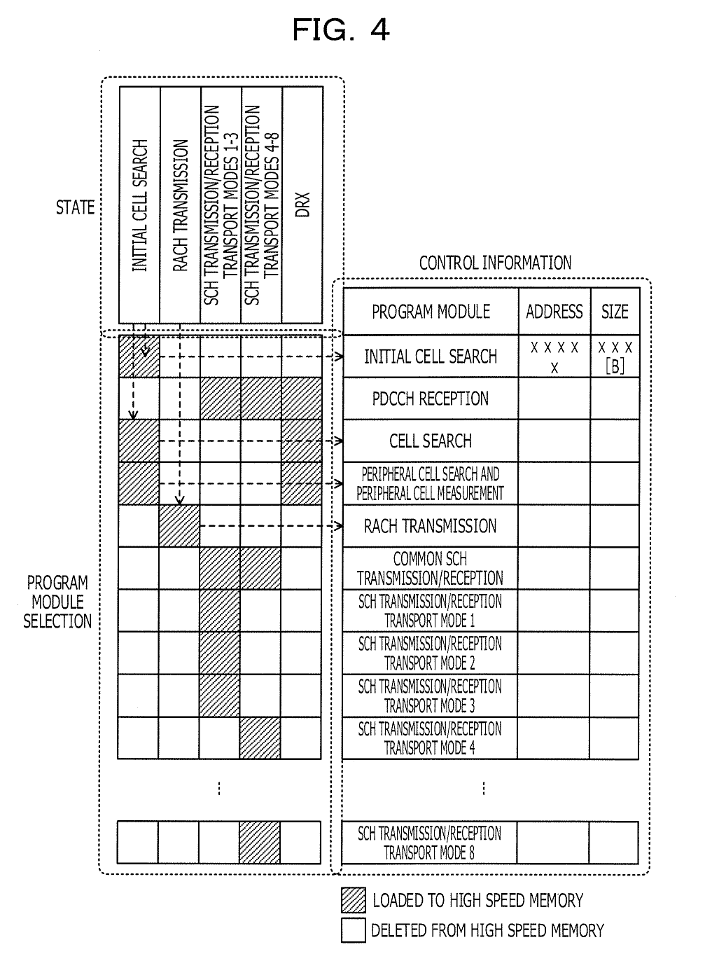

FIG. 4 is an example of transfer control information generation based on the state transition that is performed by the control information generation unit. The control information generation unit 123fb selects a program module that is executed by the DSP 123a, in accordance with a state (transition state) that is managed by the state machine 123fa. In addition, the control information generation unit 123fb generates control information that is desired for transfer of the selected program module.

As illustrated in FIG. 4, one or more program modules for one state correspond to the control information generation unit 123fb and are set and stored in the control information generation unit 123fb beforehand. For each program module, information on an address (for example, start address) and the size are stored. The address information is used when a read address from the processor (DSP 123a) is converted into an address of the high-speed memory (SRAM) 123c. In addition, the size information is used as information on the number of pieces of data when the program module is transferred from the low-speed memory (SDRAM) 141 to the high-speed memory 123c.

For example, in FIG. 4, when the transition state is in “initial cell search” (State S302), “initial cell search”, “cell measurement”, and “peripheral cell search and peripheral cell measurement” are selected as a program module. In addition, when the transition state is in “initial cell search” (State S302), the transfer control unit 123g loads the selected three program modules of “initial cell search”, “cell measurement”, and “peripheral cell search and peripheral cell measurement” to the high-speed memory (SRAM) 123c. At this time, the high-speed memory (SRAM) 123c may merely hold the selected three program modules, and the other program modules may be deleted. Alternatively, the selected three program modules are overwritten on a certain address area of the high-speed memory (SRAM) 123c, and the address area may merely be activated. In this case, the other address area may not be deleted.

For example, “PDCCH reception”, “common SCH transmission and reception”, “transport mode 1 of SCH transmission and reception”, “transport mode 2 of SCH transmission and reception”, and “transport mode 3 of SCH transmission and reception” are selected as a program module when the transition state proceeds to “transport mode 1 of SCH transmission and reception”, “transport mode 2 of SCH transmission and reception”, and “transport mode 3 of SCH transmission and reception” (State S304), and these five program modules are loaded to the high-speed memory (SRAM) 123c.

After that, “PDCCH reception”, “common SCH transmission and reception”, “transport mode 4 of SCH transmission and reception”, “transport mode 5 of SCH transmission and reception”, “transport mode 6 of SCH transmission and reception”, “transport mode 7 of SCH transmission and reception”, and “transport mode 8 of SCH transmission and reception” are selected as a program module when the transition state proceeds to “transport mode 4 of SCH transmission and reception”, “transport mode 5 of SCH transmission and reception”, “transport mode 6 of SCH transmission and reception”, “transport mode 7 of SCH transmission and reception”, and “transport mode 8 of SCH transmission and reception”, and these seven program modules are loaded to the high-speed memory (SRAM) 123c.

At that time, the two program modules (“PDCCH reception” and “common SCH transmission and reception”) that have been already loaded to the high-speed memory (SRAM) 123c may not be deleted. In this case, the newly loaded five program modules (“transport mode 4 of SO-I transmission and reception”, “transport mode 5 of SCH transmission and reception”, “transport mode 6 of SCH transmission and reception”, “transport mode 7 of SCH transmission and reception”, and “transport mode 8 of SCH transmission and reception”) are loaded to an area different from the area of the already loaded two programs.

(Timing Example of Program Module Transfer Based on the State Transition)

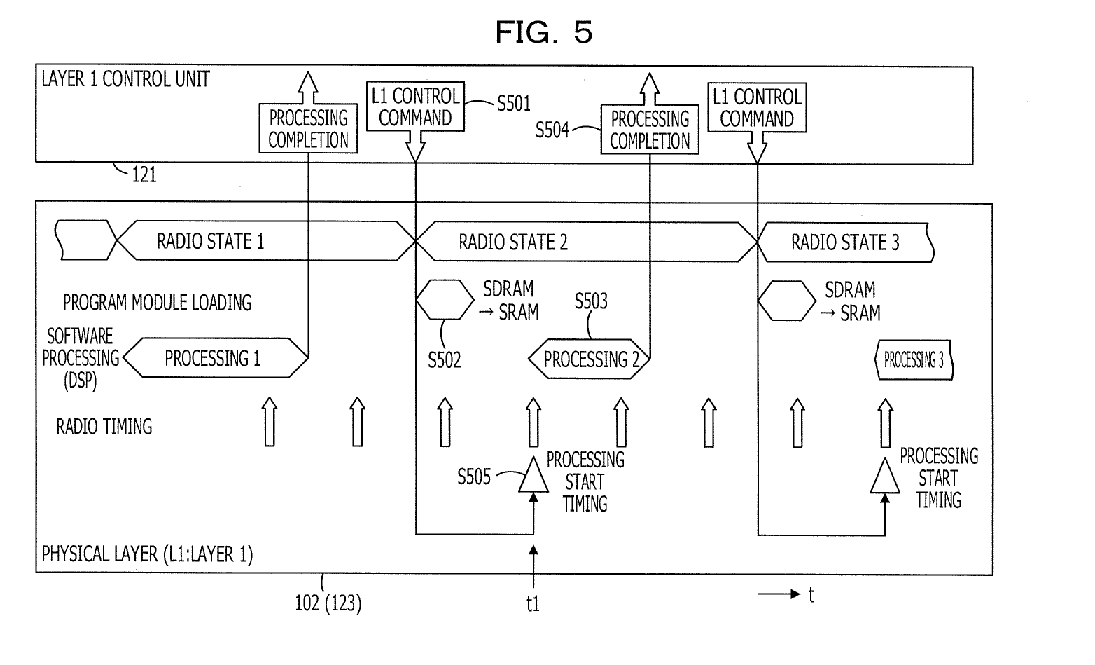

FIG. 5 is a timing chart of a program module transfer example based on the state transition. The horizontal axis indicates a time, and the vertical axis indicates processing of a function unit that is related to data transfer (each of the function units of the demodulation unit 123 that is the example of FIG. 1). When the control unit 123f receives an L1 control command 501 from the L1 control unit 121 (Step S501), the control unit 123f loads a desirable program module that corresponds to the transition state at that time, to the internal high-speed memory (SRAM) 123c (Step S502) and causes the DSP 123a to execute processing 2 (Step S503). The DSP 123a notifies the L1 control unit 121 of processing completion when the processing is completed (Step S504). The L1 control command includes time information such as processing start timing (Step S505).

In the L1 (physical layer), actual signal processing of the L1 is executed. In a radio state 1 illustrated in FIG. 5, it is assumed that processing 1 is executed. When the processing 1 is completed, the L1 control layer (L1 control unit 121) is notified of the completion of the processing 1. In the L1 control layer, the processing completion is recognized, and the function unit of the L1 (demodulation unit 123 in the example of FIG. 1) is notified of contents to be processed next as the L1 control command. In the L1, in accordance with the command, the internal state is transitioned from the radio state 1 to the radio state 2. The corresponding program module is selected in accordance with the transition of the radio state, and transferred from the low-speed memory (SDRAM) 141 to the high-speed memory (SRAM) 123c.

Timing at which the L1 control command is actually processed is described in the L1 control command as radio frame timing, or the like, and the DSP 123a starts the execution at the described timing (time t1). The transfer of the program (Step S502) is completed before the time t1 of the execution start, so that an operation of the radio signal processing is performed desirably.

The above-described control operation is repeatedly executed for each L1 control command. As a result, the L1 signal processing may be realized even by the high-speed memory (SRAM) 123c having a small capacity.

In addition, for data transport of the program module, the similar procedure may be performed even using a trigger other than the above-described L1 control command. For example, when switch of the transport mode is performed by a control signal from the base station, switch of a large program module such as the L1 control command is not performed, and switch of a program module of the corresponding portion (program module of the transport mode) may be merely performed. The switch of the transport mode is generally performed in a radio sub-frame (about 1 ms), and the size of the switched program module is about a size in which the switching may be performed easily. A data transfer capacity inside the communication SoC 102 is around several gigabits per second (Gbps), and load of around 1% of the transfer capacity is merely applied when the size of the program module is around several hundred kilobytes.

(Processing Contents of each of the Function Units that are Related to Program Module Transfer)

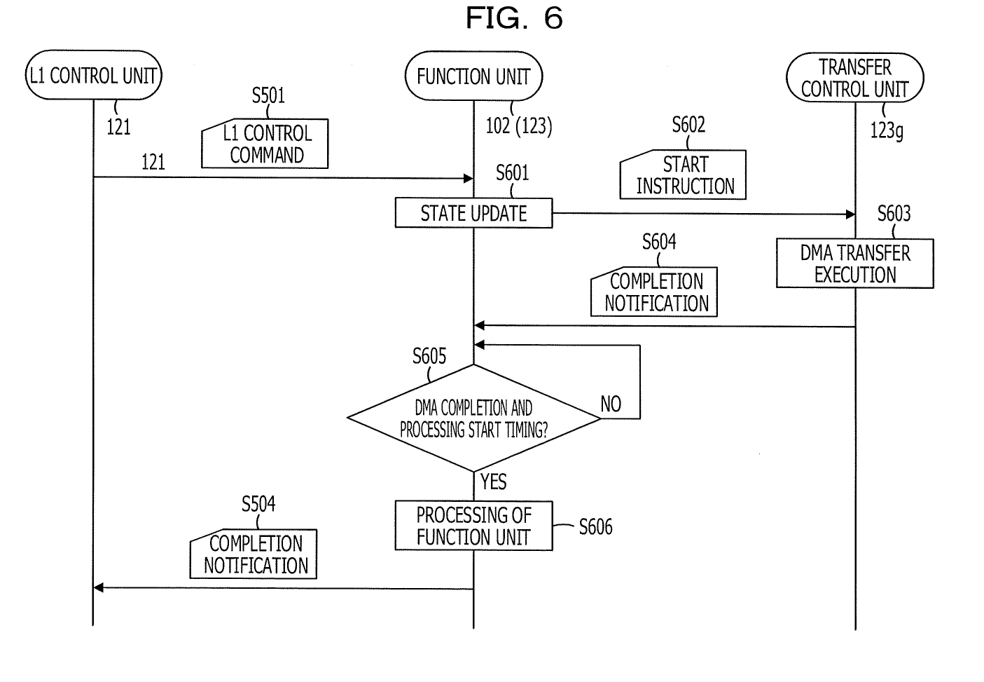

FIG. 6 is a flowchart illustrating processing contents of each of the function units that are related to the program module transfer. The L1 control unit 121 notifies the function unit of the L1 (for example, the demodulation unit 123 in FIG. 1) of contents to be processed next as an L1 control command (Step S501). In addition, the demodulation unit 123 (DSP 123a) performs completion notification to the L1 control unit 121 when the processing that is notified by the L1 control unit 121 is completed (Step S504).

Each of the function units that are provided in the communication SoC 102 executes each function, and in one function unit in the example of FIG. 1 (control unit 123f in the example of the demodulation unit 123), the state update is performed by reception of the L1 control command from the L1 control unit 121 (Step S501) (state transition in Step S601). In addition, the function unit (control unit 123f) issues a start instruction of transfer of a program module that corresponds to the transition state, to the transfer control unit 123g (Step S602). As a result, the transfer control unit 123g performs data transfer of the program module that correspond to the transition state from the low-speed memory (SDRAM) 141 to the high-speed memory (SRAM) 123c by direct memory access (DMA) (Step S603). When the data transfer of the program module is completed, the transfer control unit 123g notifies the function unit (control unit 123f) of the completion (Step S604).

After that, the function unit (control unit 123f) waits until the DMA transfer of the program module is completed and until the timing of certain processing that is executed using the program module by the DSP 123a starts (Step S605: No). In addition, the function unit (control unit 123f) causes the DSP 123a to execute the processing after the DMA transfer of the program module is completed and after the timing of the processing of the DSP 123a starts (Step S605: Yes) (Step S606). In the example of the demodulation unit 123, the DSP 123a executes the processing by the program module that is loaded to the high-speed memory (SRAM) 123c in accordance with each of the transition states. When the processing using the program module is completed, the function unit (control unit 123f) notifies the L1 control unit 121 of completion of the processing (Step S504).

(Another Configuration Example that is Related to the Data Transfer)

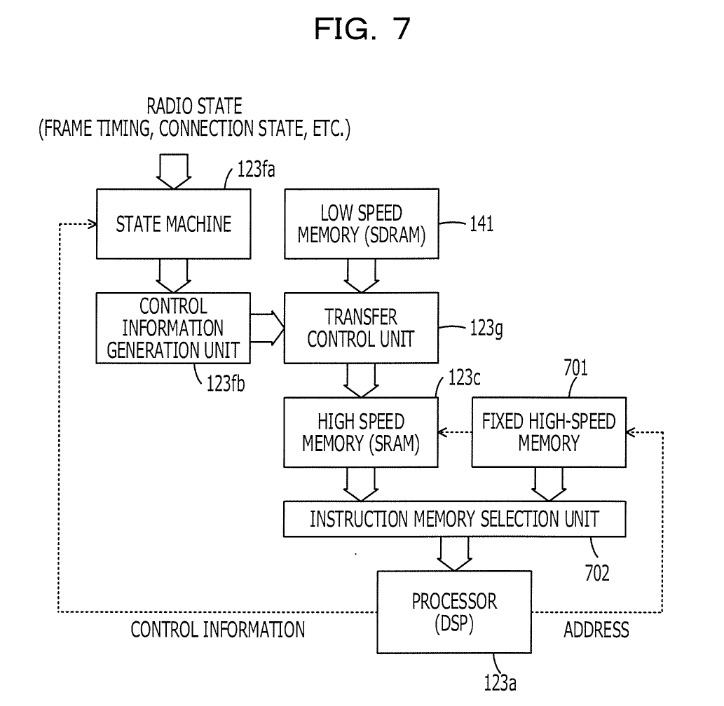

FIG. 7 is a diagram illustrating another configuration example that is related to the data transfer according to the embodiment. In FIG. 7, the same symbols are assigned to the same configuration units as the configuration units of FIG. 2. When processing based on the transition state is merely implemented (program module transfer is performed) for the processor (DSP) 123a, the processing may be executed merely by providing the above-described the high-speed memory (SRAM) 123c. However, it is probable that it is desirable that processing that is not based on the state transition (variation in the radio state), for example, exception processing, and the like are also implemented together for the DSP 123a.

In such a case, it is assumed that the transfer of the program module may not keep up urgent interrupt processing that is not directly related to the radio state transition. Therefore, as illustrated in FIG. 7, a fixed high-speed memory 701 that fixes and stores a program module that is not related to the state transition beforehand may be prepared. The fixed high-speed memory 701 do not perform data transfer for each state transition that is described above, fixes and stores a program module that is frequently used by the function unit (demodulation unit 123) (for example, a program module of “PDCCH reception” that frequently becomes a target to be loaded in FIG. 4). In addition, an instruction memory selection unit 702 uses the two high-speed memories 123c and 701 so that the two high-speed memories 123c and 701 are switched in accordance with a read address that is generated by the DSP 123a.

As a result, even when it is desirable that processing that does not depend on the transition state of radio communication such as the exception processing is implemented, delay of the processing may be avoided. In the example of FIG. 7, the two high-speed memories 123c and 701 are provided, however, the configuration is not limited to such a case, and alternatively, a dedicated fixed address that is not allowed to be overwritten may be allocated to the fixed high-speed memory 701 using one SRAM.

As described in the embodiments above, a program module to be executed is identified in accordance with the state transition that is related to the radio communication of the mobile terminal, and the program module is transferred from the low-speed memory that is provided outside the SoC to the high-speed memory that is provided inside the SoC. As a result, the program module that is desired for each state transition that is described above is transferred to the high-speed memory having a small size in the vicinity of the processor to execute the program module, and an increase in the memory chip area inside the SoC may be reduced, and the SoC at low cost may be realized. A program that is desired for the communication processing that is executed by the processor is modularized beforehand, and the transfer may be performed quickly because the program size is small, and the program may immediately become in a state of being executed by the processor.

In addition, in the embodiments, change of the radio system by the SDR may be performed flexibly. In a case of using a number of radio systems, program modules that are used for these radio systems may be stored in the low-speed memory that is provided outside the SoC, and the data transfer to the high-speed memory that is provided inside the SoC is performed at the time of execution processing of the processor.

The radio signal processing method that is described in the embodiments may be realized by executing a program that is prepared beforehand, in a computer. In addition, the program is recorded to a computer readable recording medium such as a hardware disk, a flexible disk, a compact disc-read-only memory (CD-ROM), a magneto-optical (MO), and a digital versatile disc (DVD), and executed so as to be read from the recording medium by the computer. In addition, the program may be distributed through a network such as the Internet.

In the above-described embodiments, the SDR communication is compatible with various communication systems, and in the SDR communication, the size of the high-speed memory of the SoC may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio device comprising:
a processor configured to execute radio communication processing;
a first memory configured to store a program module of the radio communication processing, and to operate at a first clock;
a second memory configured to store the program module that is transferred from the first memory, and executed by the processor, and to operate at a second clock a speed of which is higher than that of the first clock; and
a control circuit configured to:
determine the program module that is to be executed by the processor, based on a transition state of radio communication, and
control the determined program module to be transferred from the first memory to the second memory.

2. The radio device according to claim 1, wherein
a part or all of the radio communication processing is realized by software execution.

3. The radio device according to claim 1, wherein
the processor, the second memory, and the control circuit are integrated into a semiconductor chip, and
the first memory is coupled to the outside of the semiconductor chip and is configured to store all of the program modules for a plurality of functions of the radio communication.

4. The radio device according to claim 1, wherein
the control circuit is configured to:
execute state transition based on state information of the radio communication, timing of the radio communication, and state information of the radio device,
determine the program module to be transferred, based on the state transition, and
generate control information that is used to control transfer of the corresponding program module.

5. The radio device according to claim 1, wherein
the second memory is divided into a plurality of areas, and a frequently used program module of the program modules is stored in a fixed area, and the program module is transferred from the first memory to another area.

6. The radio device according to claim 1, wherein
the control circuit is configured to:
execute state transition in response to notification of an L1 control command that is related to communication control of a layer 1,
determine the corresponding program module in accordance with the state transition, and
control the program module to be transferred, in accordance with processing timing that is indicated by the L1 control command.

7. A radio signal processing method comprising:
determining a program module that is executed by a processor that executes radio communication processing, based on a transition state of radio communication;
controlling the determined program module to be transferred from a first memory that operates at a first clock to a second memory that operates at a second clock a speed of which is higher than that of the first clock; and
executing, by a processor, the program module that is transferred to the second memory.

8. The radio signal processing method according to claim 7, wherein
a part or all of the radio communication processing is realized by software execution.

9. The radio signal processing method according to claim 7, further comprising:
storing in the first memory, all of the program modules of a plurality of functions of the radio communication; and
transferring from the first memory to the second memory, the determined program module that is executed by the processor.

10. The radio signal processing method according to claim 7, further comprising:
executing state transition based on state information of the radio communication, timing of the radio communication, and state information of the radio device, the program module being determined based on the state transition; and
generating control information that is used to control transfer of the corresponding program module.

11. The radio signal processing method according to claim 7, wherein
the second memory is divided into a plurality of areas, and a frequently used program module of the program modules is stored in a fixed area, and the program module is transferred from the first memory to another area.

12. The radio signal processing method according to claim 7, further comprising:
executing state transition in response to notification of an L1 control command that is related to communication control of a layer 1, wherein
the determining includes determining the corresponding program module in accordance with the state transition, and
the controlling includes controlling the program module to be transferred, in accordance with processing timing that is indicated by the L1 control command.
